(19) United States
(12) Patent Application Publication
(10) Pub. No.: US 2018/0046116 A1
(43) Pub. Date: Feb. 15, 2018

(54) ENDLESS BELT

(71) Applicant: SUMITOMO RIKO COMPANY LIMITED, Komaki-shi (JP)

(72) Inventors: Kadai Takeyama, Komaki-shi (JP); Teruyoshi Kimpara, Komaki-shi (JP); Daiki Ito, Komaki-shi (JP)

(73) Assignee: SUMITOMO RIKO COMPANY LIMITED, Komaki-shi (JP)

(21) Appl. No.: 15/728,623

(22) Filed: Oct. 10, 2017

Related U.S. Application Data
(63) Continuation of application No. PCT/JP2016/088505, filed on Dec. 22, 2016.

(30) Foreign Application Priority Data
Dec. 24, 2015 (JP) 2015-251619

(51) Int. Cl. B32B 9/04

(52) U.S. Cl. CPC G03G 15/1685

(57) ABSTRACT

Provided is an endless belt in which surface cracks due to ozone deterioration, and a belt deformation tendency can be inhibited. The endless belt is intended for use in an electrophotographic image forming device. The endless belt includes a tubular base layer and an elastic layer laminated on the outer circumference of the base layer. The elastic layer includes a cured material of a composition containing a polycarbonate polyol, a polyisocyanate, and a rubber polymer having a double bond. A mass ratio of the polycarbonate polyol and the rubber polymer in the composition may be in a range of 5:95 to 95:5. The rubber polymer preferably contains at least one of an acrylonitrile-butadiene rubber and an epichlorohydrin rubber.

### CROSS-REFERENCE

This application is a continuation application of International Application No. PCT/JP2016/088505 filed Dec. 22, 2016, which claims priority to Japanese Patent Application No. 2015-251619 filed on Dec. 24, 2015. The entire contents of which are incorporated herein by reference.

### TECHNICAL FIELD

The present disclosure relates to an endless belt.

### BACKGROUND ART

An endless belt has been conventionally used in the field of electrophotographic image forming devices such as copiers, printers and printing machines. As this kind of an endless belt, for example, an intermediate transfer belt has been known. In the intermediate transfer belt, toner images are formed in distinction from each other by color with a plurality of photoreceptors, and the toner images are primarily transferred on the surface of the belt. The toner images having respective colors, which have been overlaid through the primary transfer, are secondarily transferred to a printing medium such as papers from the surface of the belt.

As an example of the above-mentioned endless belt, Patent document 1 discloses an endless belt for electrophotographic equipment, which includes a base layer made of a resin, and an elastic layer that is provided on the surface of the base layer and is composed of a cross-linked rubber obtained by crosslinking an acrylonitrile-butadiene rubber with a resin cross-linking agent.

Further, Patent Document 2 discloses an endless belt for electrophotographic equipment, which includes a base layer, and an elastic layer that is composed of a thermosetting material of a rubber composition including a matrix polymer containing a hydrogenated acrylonitrile-butadiene rubber and a polyisocyanate.

### PRIOR ART LITERATURE

### Patent Documents

Patent Document 1: JP-A-2010-156760
Patent Document 2: JP-A-2015-194681

### SUMMARY OF THE INVENTION

Conventional technologies, however, leave room for improvement in the following point. An endless belt receives a voltage for sending and receiving a toner on its surface. And the voltage applied for the above purpose generates ozone, and the generated ozone cleaves a double bond of the acrylonitrile-butadiene rubber. Thus, the endless belt having an elastic layer mainly composed of an acrylonitrile-butadiene rubber is problematic in that surface cracks easily occur due to deterioration on its surface caused by ozone deterioration.

In addition, the endless belt mounted on an electrophotographic image forming device as an intermediate transfer belt, is held by a photoreceptor and a primary transfer roll. The primary transfer roll is arranged at the position deviated from the photoreceptor such that the center axis of the roll is out of a plane that is perpendicular to the surface of the belt and contains the center axis of the photoreceptor. More specifically, the primary transfer roll is arranged in the direction perpendicular to the surface of the belt and at the position closer to the photoreceptor to some extent. When the photoreceptor and the primary transfer roll are positioned in such offset state as mentioned above, and the endless belt held by the photoreceptor and the primary transfer roll is statically set, a tendency to form an S-shape, namely “a belt deformation tendency”, is developed in the endless belt. If an elastic recovery rate or a deformation recovering ability of the endless belt is insufficient, the endless belt cannot be released from the belt deformation tendency even after starting rotation, so that streak-like image defects due to the belt deformation tendency occur. The endless belt having an elastic layer composed mainly of an acrylonitrile-butadiene rubber is problematic in that the above-mentioned belt deformation tendency is hardly reduced.

The endless belt described in Patent Document 2 has an elastic layer made using a matrix polymer containing a hydrogenated acrylonitrile-butadiene rubber. In this elastic layer, the number of double bonds is fewer, and the fewer number of double bonds is advantageous to inhibit surface cracks due to deterioration on its surface caused by ozone deterioration. However, Patent Document 2has no disclosure and no suggestion to inhibit the belt deformation tendency.

The present disclosure has been made in view of such a background, and it is intended to provide an endless belt in which the surface cracks due to ozone deterioration, and the belt deformation tendency can be inhibited.

One aspect of the present disclosure is an endless belt for use in an electrophotographic image forming device, which includes a tubular base layer and an elastic layer laminated on an outer circumference of the base layer, wherein,

the elastic layer includes a cured material of a composition containing a polycarbonate polyol, a polyisocyanate, and a rubber polymer having a double bond, and

the rubber polymer contains at least one of an acrylonitrile-butadiene rubber and an epichlorohydrin rubber.

In the endless belt, the composition for forming the elastic layer contains a polycarbonate polyol. Thus, the number of double bonds contained in the elastic layer can be reduced by reducing the amount of the rubber polymer having a double bond, which makes it possible to inhibit surface cracks due to ozone deterioration.

In the endless belt, an elastic recovery rate and a deformation recovering ability of the elastic layer can be enhanced even if the number of double bonds in the elastic layer is fewer. The reason can be analyzed as follows. When the composition containing a polycarbonate polyol, a polyisocyanate, and a rubber polymer having a double bond is cured, the polycarbonate polyol and the polyisocyanate react with each other to chemically bond, and simultaneously the polyisocyanates self cross-link each other in the state of taking in the rubber polymer. In the case where the rubber polymer having a double bond is such a type as reacting with the polyisocyanate, the polyisocyanate reacts with the rubber polymer to chemically bond besides the above-mentioned self-crosslinking. As a result, the polycarbonate polyol and the rubber polymer make a chemical bond through the polyisocyanate. Such a condition can compensate for reduction of the crosslinking points resulted from the reduction of the double bonds in the elastic layer. Thus, in the endless belt, it is made possible to enhance the elastic recovery rate and the deformation recovering ability of the elastic layer. Moreover, the polycarbonate polyol includes no acrylonitrile group having polarity. For this reason, intermolecular forces to be generated by the acrylonitrile group having polarity can be lowered, which also contributes to enhancement of the elastic recovery rate and the deformation recovering ability of the elastic layer. In this way, the endless belt makes it possible to inhibit the belt deformation tendency.

### BRIEF DESCRIPTION OF THE DRAWINGS

FIG. 1 is an illustration schematically showing an endless belt according to Embodiment 1.

FIG. 2 is a sectional view taken along line II-II in FIG. 1.

### DETAILED DESCRIPTION

The endless belt (seamless belt) is for use in an electrophotographic image forming device. As the electrophotographic image forming device, copiers, printers, facsimiles, multifunctional machines, and on-demand printing machines which employ an electrophotographic system using charged images, can be exemplified.

The endless belt can be used specifically as an intermediate transfer belt that is mounted on an electrophotographic image forming device. The intermediate transfer belt is an endless belt that is mounted on the electrophotographic image forming device in order that a toner image supported on a latent image carrier is primarily transferred to the surface of the belt, and then the toner image is secondarily transferred from the surface of the belt to a printing medium such as a paper. In such a use, because surface cracks due to deterioration of the elastic layer of the intermediate transfer belt which would be caused by ozone deterioration can be inhibited, and also belt deformation tendency can be inhibited, it is possible to successfully produce an image forming device that has high durability and less streak-like image defects caused by the belt deformation tendency.

The endless belt includes a base layer shaped tubular. The base layer may be mainly composed of a resin. As a resin to be used for the base layer, for example, a polyamide imide, a polyimide, a polyethersulfone resin, a fluororesin, a polycarbonate resin can be exemplified. Such resin can be used singly or in combination of two or more kinds. The resin to be used for the base layer preferably contains at least one of a polyamide imide and a polyimide. This case is advantageous for enhancement of durability of the endless belt because rigidity of the base layer is made higher.

The base layer may contain one kind or two or more kinds of various additives such as a conductive agent, a flame retardant, a crosslinking agent, a leveling agent, a filler, and an antioxidant as needed. As the conductive agent, for example, an electroconciuctive agent such as a carbon-based conductive material, a metal powder material, or an electroconductive metal oxide can be exemplified. Such conductive agent can be used singly or in combination of two or more kinds. As the carbon-based conductive material, a carbon black, a carbon nanotube, and graphite can be specifically exemplified. As the metal powder material, powdered aluminum and. powdered stainless steel can be exemplified. As the electroconductive metal oxide, a conductive zinc oxide (c-ZnO), a conductive titanium oxide (c-TiO₂) , a conductive iron oxide ic-Fe₃O₄) , and a conductive tin oxide (c-SnO₂) can be specifically exemplified. The tubular diameter and thickness of the base layer can be appropriately determined depending upon situations of the use (for example, the model, the size, or the like, of the image forming device). The tubular diameter of the base layer, for example, can be set to around 120 to 1000 mm. The thickness of the base layer, for example, can be set to around 30 to 200 μm.

The endless belt has an elastic layer laminated on the outer circumference of the base layer. The elastic layer has rubber elasticity.

In the endless belt, the elastic layer includes a cured material of a composition containing a polycarbonate polyol, a polyisocyanate, and a rubber polymer having a double bond. Specifically, the elastic layer can be made of a thermally cured material of the above-mentioned composition.

Specifically, a polycarbonate polyol is a polyol that contains a carbonate structure and a plurality of hydroxy groups. As the polycarbonate polyol, for example, a polycarbonate diol can be preferably adopted from the viewpoint of availability, and enhancement of reactivity with a polyisocyanate, flexibility, deformation recovering ability, and the like.

As the polycarbonate polyol, a polycarbonate diol containing hydroxy groups at terminals, and a polycarbonate triol containing hydroxy groups at terminals can be specifically exemplified. Such polycarbonate polyol can be used singly or in combination of two or more kinds.

The number average molecular weight (Mn) of the polycarbonate polyol can be set specifically, for example, in the range of from 300 to 3500. Such configuration makes it possible to surely achieve the above-mentioned operational effects.

The number average molecular weight (Mn) of the polycarbonate polyol can be set preferably to 400 or more, and more preferably to 500 or more from the viewpoint of enhancing the flexibility, the deformation recovering ability, and the like. From the viewpoint of enhancing compatibility with each component of the composition, the number average molecular weight (Mn) of the polycarbonate polyol can be set preferably to 3000 or less, more preferably to 2800 or less, and further more preferably to 2500 or less. It is noted that the number average

molecular weight (Mn) of the polycarbonate polyol is a molecular weight in terms of polystyrene measured, by gel permeation chromatography (GPC).

As the polyisocyanate, polyisocyanates specifically having two or more isocyanate groups in a molecule can be used from the viewpoint of encouraging the self-crosslinking as mentioned above.

As the polyisocyanate, for example, an aliphatic, alicyclic or aromatic polyisocyanate, or a derivative such as an isocyanurate, a biuret product, or an adduct product, of the aforesaid polyisocyanate can be exemplified. Specifically, as the polyisocyanate, an aliphatic, alicyclic or aromatic diisocyanate, or a derivative such as an isocyanurate, a biuret product, or an adduct product, of the aforesaid diisocyanate can be exemplif led.

As the polyisocyanate, more specifically, a hexamethylene diisocyanate(HDI), a hexamethylene

diisocyanate(HDI)-based polyisocyanate, an isophorone diisocyanate(IPDI), an isophorone diisocyanate(IPDI)-based polyisocyanate, a xylene diisocyanate (XDI), a xylene diisocyanate (XDI)-based polyisocyanate, a hydrogenated xylylene diisocyanate (H6XDI), a hydrogenated xylylene diisocyanate (H6XDI)-based polyisocyanate, a diphenylmethane diisocyanate (MDI), a diphenylraethane diisocyanate (MDI)-based polyisocyanate, a tolylene diisocyanate (TDI), a tolylene isocyanate (TDI)-based polyisocyanate, a naphtharene-di-isocyanate (NDI), and a naphtharene-di-isocyanate (NDI)-based polyisocyanate, and a derivative such as an isocyanurate, a biuret product, or an adduct product, of the above-mentioned polyisocyanates can be exemplified. Such polyisocyanate can be used. singly or in combination of two or more kinds. Among the above-mentioned polyisocyanate compounds, the compounds suffixed with “-based” include all polyisocyanates having the same isocyanate as a base, and derivatives such as an isocyanurate, a biuret product, and an adduct product, of these polyisocyanates. Specifically, for example, in the case of the “hexamethylene diisocyanate-based polyisocyanate”, various polyisocyanates having a hexamethylene diisocyanate as a base, and derivatives such as an isocyanurate, a biuret product, and an adduct product, of these polyisocyanates are included. Such definition can be applied to other polyisocyanates.

As the polyisocyanate, a hexamethylene diisocyanate, a hexamethylene diisocyanate-based isoyanate, and the like can be preferably used. This case makes it easy to provide an endless belt that exhibits excellent toner

transferability because of its excellent flexibility on the surface of the elastic layer when used as an intermediate belt.

As the polyisocyanate, more specifically, a blocked polyisocyanate in which isocyanate groups are blocked with a blocking agent, can be used. In the blocked polyisocyanate, the isoyanate groups are protected by the blocking agent, thus the reactivity at room temperature is lower than that of non-blocked polyisocyanate.

Consequently, when the blocked polyisocyanate is adopted, the endless belt tends not to suffer deterioration caused by moisture in the manufacturing environment and/or effected from a period of manufacturing time. For this reason, the blocked polyisocyanate can be suitably used. Here, the blocking agent is dissociated by the neat applied during cu.ri.ng of the compound, so that active isocyanate groups are reproduced. As for the blocking agent, for example, any compound such as an alcohol-based compound, a phenolic compound, an active methylene-based compound, a mercaptan compound, an acid amide compound, an acid imide compound, an imidazole-based compound, an urea compound, an oxime-based compound, an amine-based compound, an imide-based compound, and a pyrimidine compound can be exemplified. The polyisocyanate may be modified with a polytetramethylene ether glycol (PTMG), a polypropylene glycol (PPG), or the like.

In the endless belt, the content of the isocyanate groups contained in the composition for use in the elastic layer can be set in the range of from 1 to mass percent. If the content of the isocyanate groups contained in the composition for use in the elastic layer is 1 mass percent or more, enhancement of the wear resistance of the surface of the elastic layer is made easier. This is because sufficient self-crosslinking between the polyisocyanates is made to easily occur, so that the number of a cross-linked structure formed by the self-crosslinking increases. The content of the isocyanate groups in the composition can be set preferably to 1.5 mass percent or more, more preferably to 2.0 mass percent or more, further more preferably to 3.0 mass percent or more, and still further more preferably to 5.0mass percent or more. On the other hand, in a case where the content of the isocyanate groups contained in the composition for use in the elastic layer is mass percent or less, it is made easy to surely obtain the flexibility of the elastic layer while inhibiting increase of the hardness of the surface of the elastic layer. As a result, for example, when the endless belt is used as an intermediate transfer belt, the toner transferability is easily enhanced. This is considered because excessive self-crosslinking tends not to occur in the polyisocyanates. In order to enhance the flexibility of the surface of the elastic layer, the content of the isocyanate groups contained in the composition for use in the elastic layer can be set to 13 mass percent or less, more preferably to 11 mass percent or less, and further more preferably to 9 mass percent or less. Here, the content (mass percent) of the isocyanate groups contained in the composition can be calculated through the following calculation formula, i.e., [An addition amount of the polyisocyanate in solid contents (mass parts) based on a total amount of 100 parts by mass of the polyol component and the rubber component in the composition]×[An amount of an effective NCO in the polyisocyanate (mass percent)]. The effective NCO means an isocyanate group that is reactive during heat curing of the polyisocyanate, the amount of the effective NCO can be determined by potentiometric titration. The addition amount of the polyisocyanate can be determined so that the content of the isocyanate groups in the composition for use in the elastic layer falls within the above-specified range, considering the kind of the polyisocyanate, and the like.

The rubber polymer having a double bond can contain specifically, for example, at least one of an acrylonitrile-butadiene rubber (NBR) and an epichlorohydrin rubber (ECO). This case makes it possible to produce an endless belt in which the surface cracks due to ozone deterioration, and the belt deformation tendency can be inhibited while reduction of the flexibility in the elastic layer is restrained. In addition, because the rubber polymer includes a lot of polar groups, there is an advantage that uniform, conductivity is easily provided to the elastic, layer. Here, the acrylonitrile-butadiene rubber and the epichlorohydrin rubber can be used singly or in combination of two or more kinds.

More specifically, the rubber polymer preferably contains an amine-modified acrylonitrile-butadiene rubber. In this case, the polyisocyanate and the rubber polymer react each other to chemically bond when the composition is cured. Consequently, an endless belt in which an elastic recovery rate and a deformation recovering ability of the elastic layer are easily enhanced can be produced. The reason can be analyzed as follows. The polycarbonate polyol and the polyisocyanate react each other to chemically bond, and simultaneously the polyisocyanate and the rubber polymer react with each other to chemically bond, and further the polyisocyanates self-crosslink each other in the state of taking in the rubber polymer, thus increasing the number of the crosslinking points. And, the increased number of the crosslinking points effectively compensates for reduction of the crosslinking points resulted from the reduction of the double bonds in the elastic layer.

In the above-mentioned composition, the mass ratio of the polycarbonate polyol and the rubber polymer can be set specifically in the range of 5:95 to 95:5. In this range, inhibition of the surface cracks due to ozone deterioration, and inhibition of the belt deformation tendency can be surely made. The mass ratio of the polycarbonate polyol and the rubber polymer can be set preferably in the range of 10:90 to 90:10, more preferably in the range of 15:85 to 85:15, further more preferably in the range of 20:80 to 80:20, still further more preferably in the range of 25:75 to 75:25, and still further more preferably in the range of 30:70 to 70:30.

More specifically, the mass ratio of polycarbonate polyol in the composition can be configured preferably to be equal to or larger than the mass ratio of rubber polymer, more preferably to be larger than the mass ratio of rubber polymer. In this case, inhibition of the surface cracks due to ozone deterioration, and inhibition of the belt deformation tendency can be made more surely.

The composition for use in an elastic layer can contain, for example, an ether-based polyol and the like in order to enhance flexibility of the elastic layer, easily provide uniform conductivity, and so on. Also, the composition for use in an elastic layer can contain a hydrogenated acrylonitrile-butadiene rubber (HNBR), a hydrogenated. butadiene rubber (HBR) , and the like in order to reduce the number of double bonds in the elastic layer. Further, the composition for use in an elastic layer can contain a chloroprene rubber, and the like in order to adjust an electric resistance in the elastic layer, flameproofing of the elastic layer, and so on,

The composition for use in an elastic layer can contain one kind, or two or more kinds of various additives including a conductive agent, a flame retardant, a crosslinking agent, a crosslinking assistant, a vulcanizer, a vulcanization accelerator, an acid acceptor, a lubricant, a filler, a catalyst, and the like, as needed.

As the conductive agent, an ion conductive agent or an electroconductive agent may be adopted, or the both may be contained together. In order to readily achieve a uniform volume electric resistance, the ion conductive agent is preferably adopted for the conductive agent. As the ion conductive agent, a quaternary ammonium salt, a phosphoric ester, a sulfonate, an aliphatic polyhydric alcohol, an aliphatic alcohol sulfate, and an ionic liquid, can be exemplified. Such ion conductive agent can be used singly or in combination of two or more kinds. As the electroconductive agent, the same ones set forth precedingly in the description of the base layer can be exemplified. Such electroconductive agent can be used singly or in combination of two or more kinds.

As the flame retardant, an organic flame retardant or an inorganic flame retardant may be adopted, or the both may be contained together. In order to achieve flame-retardant effects in a relatively small amount and hardly impair the flexibility of the elastic layer, an organic flame retardant is preferably used as the flame retardant. In addition, when both of an organic flame retardant and an inorganic flame retardant are used together, there is an advantage that the flame-retardant effects can be achieved at relatively low cost.

Examples of the organic flame retardant include, specifically, a polycyclic benzene ring compound, a bromine-based flame retardant, and a phosphorus-based flame retardant, and the like. As the polycyclic benzene ring compound, a decabromo diphenyl ether, a tetrabromobisphenol A and its derivative, a bis-(pentabromopnenyl)ethane can be exemplified. As the bromine-based, flame retardant, a brominated polystyrene and a polybrominated styrene are exemplified. As the phosphorus-based flame retardant, an aromatic phosphoric acid ester, an aromatic condensed phosphoric acid ester, a halogen-containing phosphoric acid ester, a halogen-containing condensed phosphoric ester, a phosphazene derivative are exemplified. Such organic flame retardant can be used singly or in combination of two or more kinds. Examples of the inorganic flame retardant include, specifically, an antimony-based flame retardant such as an antimony trioxide and an antimony pentaoxide, and a metal hydroxide-based flame retardant such as an aluminum hydroxide and a magnesium hydroxide. Such inorganic flame retardant can be used singly or in combination of two or more kinds.

The thickness of the elastic layer can be determined considering flexibility, flame retardance, curvature, wear resistance, use situation, and so on. The thickness of the elastic layer can be set preferably to 3 μm or more,

more preferably to jam or more, further more preferably to 10 μm or more, still further more preferably to 30 μm or more. Further, the thickness of the elastic layer can be set preferably to 500 μm or less, more preferably to 400μm or less, further more preferably to 300 μm or less.

In the endless belt, the elastic layer may be configured specifically to have its surface exposed outside, or to have a surface layer formed of a resin or the like along the outer circumference surface of the elastic layer.

In the endless belt, the elastic layer can be configured to have no peak of tan(loss tangent) in a temperature range of from 20° C to 40° C. According to such configuration, the elastic layer experiences no large fluctuation in viscoelastic behavior within the range of from 20° C to 40° C which includes the temperature under which the endless belt is used. For this reason, this configuration makes it possible to readily avoid image irregularities to be caused by the fluctuation in viscoelastic behavior of the elastic layer, thus producing an endless belt that is advantageous for enhancing the resistance against environment dependence.

The above-mentioned tancan be determined in the

following way. A sample piece of the elastic layer (1.6mm×1.6 mm×30 mm) is prepared from the elastic layer and fixed on a dynamic viscoelasticity measuring device (DVE rheo-spectrum manufactured by Rheology Co., Ltd.), setting a measured length to be mm. Then, the tanδ (loss tangent) is measured at each degree within the range of from 20° C to 40° C, raising a temperature at a temperature rising rate of 3° C./min while giving sinusoidal distortion with a displacement amplitude of ±10 μm and a frequency of 10 Hz.

The abovementioned configurations can be optionally combined as needed to achieve the above-mentioned operational effects.

### Embodiment

Hereinafter, an endless belt according to an embodiment will be specifically described with use of drawings.

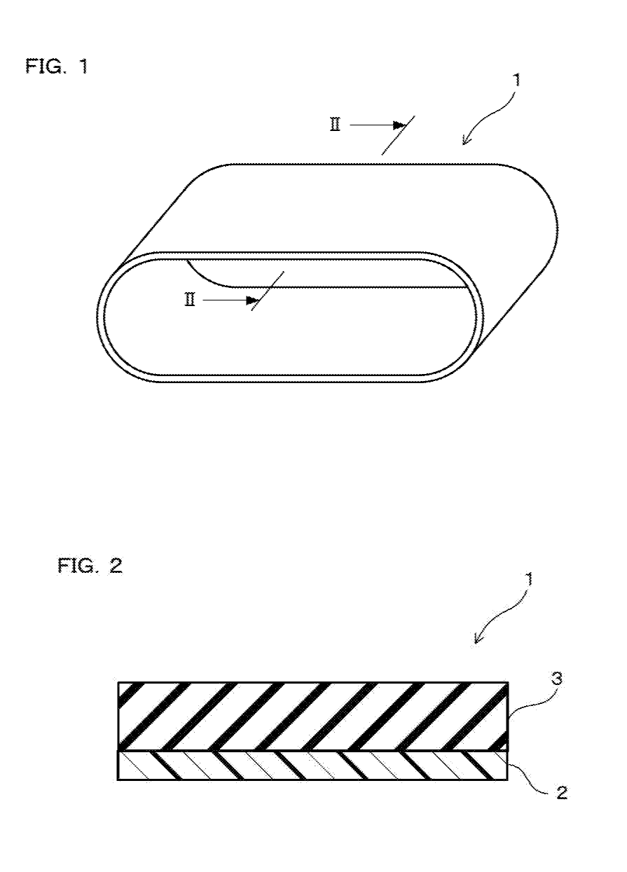

An endless belt 1 as shown in FIGS. 1 and 2, is for use in an electrophotographic image forming device. In this embodiment, the endless belt 1 is mounted on an electrophotographic image forming device and to be used as an intermediate transfer belt.

The endless belt 1 includes a tubular base layer 2 and an elastic layer 3that is laminated on an outer circumference of the base layer 2. Specifically, the endless belt 1 has a two-layer structure in which the elastic layer 3 is laminated along the outer circumference surface of the base layer 2. Here, FIG. 1 omits a detailed illustration of the layer structure of the belt. In the present embodiment, the base layer 2 is composed of a polyamide imide or a polyimide which contains an electroconductive agent,

In the endless belt 1, the elastic layer 3 includes a cured material of a composition containing a polycarbonate polyol, a polyisocyanate, and a rubber polymer having a double bond.

A plurality of samples of an endless belt were prepared, each having a different configuration for evaluation. Hereinafter, an experimental example will be described below.

### (Experimental Example)

### <Preparation of Material for Forming Base Layer>

100 mass parts of a polyamide imide (PAI) (VYLOMAX HR-16NN manufactured by TOYOBO CO., LTD.), mass parts of a carbon black (DENKA BLACK manufactured by Denka Company Limited), and 800 mass parts of N-methyl-2-pyrrolidone (NMP) were mixed to prepare a material for forming a base layer. The material for forming a base layer was conditioned to be in liquid form having a viscosity adjusted to be approximately 10,000 mPa-s (measured with a Brookfield viscometer at 25° C) . This material for forming a base layer is commonly used for preparation of each sample in the present experimental example.

### <Preparation of Composition for Forming Elastic Layer>

The following materials were prepared for preparation of each composition.

Polycarbonate Polyol-
Polycarbonate diol (1) (containing —OH (hydroxy
group) at both terminals, a number average molecular
weight: 500)
“PLACCEL CD205PL” manufactured by Daicel Corporation)
Polycarbonate diol (2) (containing —OH (hydroxy
group) at both terminals, a number average molecular
weight: 1000)
(“DURANOL T5651” manufactured by Asahi Kasei Chemicals
Corporation)
Polycarbonate diol (3) (containing —OH (hydroxy
group) at both terminals, a number average molecular
weight: 2000)
(“BENEBiOL NL2050B” manufactured by Mitsubishi
Chemical Corporation)
Polycarbonate diol (4) (containing —OH (hydroxy
group) at both terminals, a number average molecular
weight: 3000)
(“KURARAY Polyol C-3090” manufactured by KURARAY
CO., LTD.)
Polyisocyanate-
Diisocyanate (1) (a blocked type of 1,6-
hexamethylene diisocyanate, an effective content of NCO:
15.6 mass percent)
(“Takenate B882N” manufactured by Mitsui Chemicals Co.,
Ltd.)
Diisocyanate (2) a blocked type of
polytetramethylene ether glycol (PTMG) modified tolylene
diisocyanate, an effective content of NCO: 5.6 mass
percent)
(“ADIPRENE BL60” manufactured by Chemtura Corporation)
Diisocyanate (3) (a blocked type of
polypropylene glycol (PPG) modified 1.6-hexamethylene
diisocyanate, an effective content of NCO: 6.0 mass
percent)
(“Duranate E402-B80B” manufactured by ASAHI KASEI
CHEMICALS CORPORATION)
Urethane Resin-
Polycarbonate Urethane Resin
(“NIPPOLAN 5196” manufactured by Tosoh Corporation)
Rubber Polymer Having Double Bond
Amine-modified acrylonitrile-butadiene rubber
(“ATBN1300 × 45” manufactured by PTI Japan Corporation)
Acrylonitrile-butadiene rubber
(“Nipol DN101” manufactured by Zeon Corporation)
Epichlorohydrin rubber
(“EPICHLOMER CG-102” manufactured by DAISO
CHEMICAL CO., LTD.)
Other Components-
Acid Acceptor (Zinc oxide)
(“Zinc Oxide II” manufactured by Seido Chemical Industry
Co., Ltd..)
Lubricant (Stearic acid)
(“Stearic Acid Sakura” manufactured by NOF CORPORATION)
Vulcanizer (Sulfur powder)
(“Sulfur PTC” manufactured by Tsurumi Chemical Industry
Co., ltd.)
Vulcanization accelerator (1)
(“SANCELER DM” manufactured by SANSHIN CHEMICAL
INDUSTRY CO., LTD.)
Vuicanization accelerator (2)
(“SANCELER TT” manufactured by SANSHIN CHEMICAL
INDUSTRY CO., LTD.)
Inorganic flame retardant (Magnesium hydroxide)
(“Kisuma 5A” manufactured by Kyowa Chemical Industry Co.,
Ltd.)
Organic flame retardant (Trimethyl phosphate)
(“TMP” manufactured by Daihachi Chemical Industry Co.,
Ltd.)
Halogen-based flame retardant (Ethylene
bistetrabromophthalimide)
(“SAYTEX BT-93/W” manufactured by Albemarle Japan
Corporation)
Ion conductive agent (Tetrabutylammonium chloride)
(Manufactured by Tokyo Chemical Industry Co., Ltd.)
Electronic conductive agent (Carbon black)
(“Special Black 4” manufactured by Orion Engineered
Carbons LLC)

In preparation of liquid compositions for use in forming elastic layers of endless belt samples referred to as Samples 1 to and Samples 1C to 3C, materials listed in Table 1 were blended into a cyclohexanone at a predetermined ratio to control the solid content of the resulting compositions to be 60 mass percent.

### <Preparation of Endless Belt Samples>

As a base body, a cylindrical mold made of aluminum was prepared. A dispenser (a device for quantitatively discharging a liquid) with two nozzles was also prepared. The nozzles of the dispenser are needle nozzles having an inner diameter cp of 1 mm. Then, the material for forming a base layer and the composition for forming an elastic: layer, both prepared in the above-mentioned manner, were put in separate air pressure tanks, and the mold and the nozzles were set in such a manner to leave a clearance of 1 mm between the outer circumference surface of the mold and each nozzle. Next, with being kept upright, the mold was rotated around the axis at a rotation speed of 200 rpm, and at the same time the nozzles for injecting the material for forming a base layer was moved downward in the axial direction at a moving speed of 1 mm/sec, and the material for forming a base layer was fed by pressure to the nozzle by pressurizing the air pressure tank with a pressure of 0.4 MPa and was injected from the nozzle so as to coat the outer circumference of the mold in a spiral manner. In this way, the resulting coating continuously spread on the mold in the spiral manner formed an entire coating. Subsequently, the entire coating thus formed was subjected to a heat treatment under the condition so as to raise the temperature of the coating to 250° C spending 2 hours and maintain the temperature of 250° C for 1 hour. In this way, a tubular base layer made of a poiyamide imide (thickness: 80μm; tubular diameter φ: 320 mm) was formed.

Next, the mold having the base layer formed thereon was rotated around the axis at a rotation speed of 200rpm, and at the same time the nozzle for injecting the composition for forming an elastic layer was moved downward in the axial direction at a moving speed of 1mm/sec, and the composition for forming an elastic layer was fed by pressure to the nozzle by pressurizing the air pressure tank with a pressure of 0.8 MPa and was injected from the nozzle so as to coat the surface of the base layer on the outer circumference surface of the mold in a spiral manner. In this way, the resulting coating continuously spread on the base layer in the spiral manner formed an entire coating. Subsequently, the entire coating thus formed was subjected to a heat treatment under the condition so as to raise the temperature to 170° C spending 3 hours and maintain the temperature of 170° C for 60 minutes, thereby to cure the composition. In this way, an elastic layer made of a cured material of each composition, (thickness: 200 μm) was laminated along the outer circumference of the tubular base layer.

Then, while the mold having the elastic layer formed thereon was rotated around the axis at a rotation speed of 60 rpm, the elastic layer was subjected to a UV treatment in the following way. That is, the surface of the elastic layer was irradiated with ultraviolet rays using an

ultraviolet irradiation machine (“UB031-2A/BM” (mercury lamp type) manufactured by Eye Graphics Co.) under the following conditions: an irradiation intensity is 120mW/cm²; an irradiation time is 180 seconds; and a distance between the light source and the surface of the elastic layer is 100 mm.

And then, the mold was removed by blowing a high-pressure air between one end edge of the base layer and the outer circumference surface of the mold. The endless belt samples referred as Samples 1 to and Samples 1C to 3C were thus prepared.

### <Ozone Resistance>

Each composition prepared as described above was

subjected to a heat treatment under the same condition as in preparation of the endless belts to prepare an elastic sheet. Next, a Type 1 dumbbell-shaped test specimen was taken from the elastic sheet corresponding to each composition. Then, the specimen was exposed to an air atmosphere at an ozone concentration of 5ppm (500pphm) for 500 hours. Then, a tensile strain in 10% elongation was applied to the specimen to check for any surface crack and/or any breakage. The case where no surface crack was found visually or with use of a magnifier of 10 magnifications was evaluated as being excellent in ozone resistance, and rated as “A”. The case where no surface crack was visually found, but any surface crack was found with use of the magnifier of magnifications was evaluated as being good in ozone resistance, and rated as “B”. The case where a lot of surface cracks were visually found or breakage was caused, was evaluated as having remarkable ozone deterioration, and rated as “C”.

<Resistance to Belt Deformation Tendency>For evaluation of the resistance to the belt deformation tendency, an elastic recovery rate and a deformation recovering ability were examined.

### Elastic Recovery Rate

A universal hardness tester (“Fischer Scope H100” manufactured by Fisher Inc.) was employed. A stylus of the tester was pushed against the surface of the elastic layer of each endless belt at a constant load of 2 mN per 30 seconds to calculate the elastic recovery rate. The calculation was performed based on the calculation formula, (η_{IT}=Wₑₗₐₛₜ/Wₜₒₜₐₗ×100) , as specified in ISO-14577-1 for indentation work.

Deformation Recovering Ability

The surface of the elastic layer of each endless belt was pressed by a metal roller having a diameter of 15 mm under a load of 1 kg for 360 seconds, thereafter, after seconds elapse, the deformation state of the surface of the elastic layer was visually observed. The case where no contact trace of the roller was found on the surface of the elastic layer after the lapse of seconds, was evaluated as being excellent in deformation recovering ability, and rated as “A”. The case where a little bit of contact trace of the roller was found on the surface of the elastic layer after the lapse of seconds, was evaluated as being good in deformation recovering ability, and rated as “B”. The case where any contact trace of the roller was clearly found on the surface of the elastic layer after the lapse of seconds, was evaluated as being inferior in deformation recovering ability, and rated as “C”.

### Measurement of Tanδ, Image Irregularities

In accordance with the above-mentioned manner, tanδ of the elastic layer of each endless belt was measured to check for the peak of tanδ. Each endless belt was mounted on an electrophotographic digital full-color multifunctional machine as an intermediate transfer belt, and a full-color image was output under an environment of 25° C. ×53%RH. The case where a good image was formed with hardly any occurrence of image irregularity in the initial image, was rated as “A”. The case where a tolerable image with no problem in use was formed although any image irregularity was found in the initial image, was rated as “B”.

Table 1 shows the configurations of the endless belt samples listed in detail and the evaluation results all together.

TABLE 1

| | | Sample | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 1C | 2C | 3C |
| Composition | Polycarbonate Polyol | | | | | | | | | | | | | |
| (mass parts) | Polycarbonate Diol (1) | 95 | 50 | 5 | — | — | — | 50 | 50 | 50 | 50 | — | — | — |
| | Polycarbonate Diol (2) | — | — | — | 50 | — | — | — | — | — | — | — | — | — |
| | Polycarbonate Diol (3) | — | — | — | — | 50 | — | — | — | — | — | — | — | — |
| | Polycarbonate Diol (4) | — | — | — | — | — | 50 | — | — | — | — | — | — | — |
| | Polyisocyanate | | | | | | | | | | | | | |
| | Diisocyanate (1) | 40 | 40 | 40 | 40 | 40 | 40 | 40 | 40 | — | — | 40 | 40 | — |
| | Diisocyanate (2) | — | — | — | — | — | — | — | — | 105 | — | — | — | — |
| | Diisocyanate (3) | — | — | — | — | — | — | — | — | — | 95 | — | — | — |
| | Urethane Resin | — | — | — | — | — | — | — | — | — | — | — | — | 90 |
| | Rubber Polymer having | | | | | | | | | | | | | |
| | Double Bond | | | | | | | | | | | | | |
| | Amine-modified | 5 | 50 | 95 | 50 | 50 | 50 | — | — | 50 | 50 | 100 | — | — |
| | Acrylonitrile-butadiene | | | | | | | | | | | | | |
| | Rubber | | | | | | | | | | | | | |
| | Acrylonitrile-butadiene | — | — | — | — | — | — | 50 | — | — | — | — | — | 50 |
| | Rubber | | | | | | | | | | | | | |
| | Epichlorohydrin Rubber | — | — | — | — | — | — | — | 50 | — | — | — | 100 | — |
| | Other Components | | | | | | | | | | | | | |
| | Acid Acceptor | — | — | — | — | — | — | 10 | — | — | — | — | 10 | — |
| | Lubricant | — | — | — | — | — | 2 | 2 | — | — | — | — | 2 | — |
| | Vulcanizer | — | — | — | — | — | 3 | 3 | — | — | — | — | 3 | — |
| | Vulcanization | — | — | — | — | — | 1 | 1 | — | — | — | — | 1 | — |
| | accelerator (1) | | | | | | | | | | | | | |
| | Vulcanization | — | — | — | — | — | 1 | 1 | — | — | — | — | 1 | — |
| | accelerator (2) | | | | | | | | | | | | | |
| | Inorganic Flame | 50 | 50 | 50 | 50 | 50 | 50 | 50 | 50 | 50 | 50 | 50 | 50 | 50 |
| | Retardant | | | | | | | | | | | | | |
| | Organic Flame Retardant | 15 | 15 | 15 | 15 | 15 | 15 | 15 | 15 | 15 | 15 | 15 | 15 | 15 |
| | Halogen-based Flame | 10 | 10 | 10 | 10 | 10 | 10 | 10 | 10 | 10 | 10 | 10 | 10 | 10 |
| | Retardant | | | | | | | | | | | | | |
| | Ion Conductive Agent | 1 | 1 | 1 | 1 | 1 | 1 | 1 | 1 | 1 | 1 | 1 | 1 | 1 |
| | Electroconductive Agent | 5 | 5 | 5 | 5 | 5 | 5 | 5 | 5 | 5 | 5 | 5 | 5 | 5 |
| Evaluation | Ozone Resistance | A | A | B | A | A | B | A | A | A | A | C | B | C |
| | Resistance to Belt | | | | | | | | | | | | | |
| | Deformation Tendency | | | | | | | | | | | | | |
| | Elastic Recovery Rate | 89 | 75 | 60 | 73 | 70 | 65 | 68 | 80 | 80 | 78 | 60 | 50 | 58 |
| | (%) | | | | | | | | | | | | | |
| | Deformation Recovering | A | A | B | A | A | B | B | A | A | A | B | C | C |
| | Ability | | | | | | | | | | | | | |
| | Peak of Tan δ of Elastic | Found | Found | Found | Found | Found | Found | Found | Found | Not- | Not- | Found | Found | Found |
| | Layer | | | | | | | | | found | found | | | |
| | Image Irregularity | B | B | B | B | B | B | B | B | A | A | B | B | B |
| | (25° C.) | | | | | | | | | | | | | |

Table 1 shows the followings. Sample 1C of an endless belt contains no polycarbonate polyol in the composition for forming an elastic layer, but a large amount of an amine-modified. acrylonitrile-butadiene rubber. For this reason, Sample 1C endless belt contains a large number of double bonds in the elastic layer. Thus, the surface of the endless belt tends to readily deteriorate in accompany with cleavage of the double bonds by ozone, so that the surface cracks and the breakages readily occurred.

Similarly to Sample 1C, Sample 2C of an endless belt contains no polycarbonate polyol in the composition for forming an elastic layer, but a large amount of an epichlorohydrin rubber. An epichlorohydrin rubber is inherently inferior in elastic recovery rate and deformation recovering ability. For this reason, Sample 2C endless belt hardly released from the belt deformation tendency after the belt was started to rotate.

Sample 3C of an endless belt has an elastic layer formed of a composition containing a polycarbonate urethane resin obtained by precedently reacting a polycarbonate polyol and a polyisocyanate, and a rubber polymer having a double bond. In other word, the elastic layer of Sample 3C endless belt was not formed of a cured composition containing a polycarbonate polyol, a polyisocyanate, and a rubber polymer having a double bond. For this reason, Sample 3C endless belt did not successfully inhibit surface cracks caused by ozone deterioration, and the belt deformation tendency.

By contrast, in endless belts referred to as Samples 1 to 10, a polycarbonate polyol is contained in each composition for forming an elastic layer. Consequently, in these endless belts, the amount of the rubber polymer having a double bond can be lowered, and thus the number of the double bonds contained in the elastic layers can be reduced, thereby to inhibit surface cracks caused by ozone deterioration. In these endless belts, it is also made possible to enhance the elastic recovery rate and the deformation recovering ability of the elastic layer even if the number of the double bonds contained in the elastic layer is reduced. Thus, it is concluded that the belt deformation tendency can be easily inhibited in these endless belts.

In addition, the mutual comparison of Samples 1 to of an endless belt finds the followings. Specifically, the comparison among Samples 1 to 3 finds that inhibition of the surface cracks to be caused by ozone deterioration, and of the belt deformation tendency is surely made. Further, the comparison finds that if the mass ratio of the polycarbonate polyol is equal to or larger than the mass ratio of the rubber polymer, the above-mentioned operational effects can be achieved more surely.

The comparison among Sample 2, Samples 4 to 6 of an endless belt finds that inhibition of the surface cracks to be caused by ozone deterioration, and of the belt deformation tendency is surely made if the number average molecular weight of the polycarbonate polyol falls within the range of from 300 to 3500. Chiefly in order to surely obtain ozone resistance, it is apparently effective to set an upper limit of the number average molecular weight of the polycarbonate polyol to 3000 or less, preferably to less than 3000. This is because the number average molecular weight, in the above specified range contributes to increase compatibility of the polycarbonate polyol with the other component(s) in the composition.

The comparison between Sample 2 and Sample 7 of an endless belt finds that the resistance to the belt deformation tendency was enhanced if the rubber polymer contains an amine-modified acrylonitrile-butadiene rubber. The reason for such property can be analyzed as follows. The polycarbonate polyol and the polyisocyanate react each other to chemically bond, and simultaneously the polyisocyanate and the rubber polymer react with each other to chemically bond, and further the polyisocyanates self-crosslink each other in the state of taking in the rubber polymer, thus increasing the number of the crosslinking points. And, the increased number of the crosslinking points effectively compensates for reduction of the crosslinking points resulted from the reduction of double bonds in the elastic layer.

The comparison among Samples 1 to 8 and Samples 9 to of an endless belt confirmed that image irregularities to be caused by the fluctuation in viscoelastic behavior of the elastic layer was readily avoided if the elastic layer has no peak of tanin the temperature range of from 20° C to 40° C, thus producing an endless belt that is advantageous for enhancing the resistance against environment dependence.

As above, the embodiment of the present disclosure has been described in detail, but the present disclosure is not limited to the above-mentioned embodiment and experimental example. Various modifications are possible as long as the spirit of the present disclosure is not impaired.

1. An endless belt for use in an electrophotographic image forming device, comprising:
a tubular base layer; and
an elastic layer laminated on an outer circumference of the base layer, wherein,
the elastic layer comprises a cured material of a composition containing a polycarbonate polyol, a polyisocyanate, and a rubber polymer having a double bond, and
the rubber polymer contains at least one of an acrylonitrile-butadiene rubber and an epichlorohydrin rubber.

2. The endless belt according to claim 1, wherein the polycarbonate polyol has a number average molecular weight of from 300 to 3500.

3. The endless belt according to claim 2, wherein the rubber polymer further contains an amine-modifled acrylonitrile-butadiene rubber.

4. The endless belt according to claim 3, wherein the elastic layer has no peak of tanin a temperature range of from 20° C to 40° C.

5. The endless belt according to claim 4, wherein a mass ratio of the polycarbonate polyol and the rubber polymer in the composition falls within a range of 5:95 to 95:5.

6. The endless belt according to claim 5, wherein the polycarbonate polyol has a number average molecular weight of from 500 to 2500.

7. The endless belt according to claim 6, wherein the polyisocyanate is a blocked type of 1,6-hexamethylerte diisocyanate.

8. The endless belt according to claim 7, wherein a mass ratio of the polycarbonate polyol and the rubber polymer in the composition falls within a range of 30:70to 70:30.

9. The endless belt according to claim 8, wherein the base layer has a thickness of from 30 to 200μm.

10. The endless belt according to claim 9, wherein the elastic: layer has a thickness of from 30 to 300 μm.

11. The endless belt according to claim 10, wherein the composition further contains at least one selected from the group consisting of an organic flame retardant, an inorganic flame retardant, and a halogen-based flame retardant.

12. The endless belt according to claim 11, wherein the composition further contains at least one of an ion conductive agent and an electroconductive agent.

13. The endless belt according to claim 1, wherein the polycarbonate polyol has a number average molecular weight of from 500 to 2500.

14. The endless belt according to claim 1, wherein the polyisocyanate is a blocked type of 1,6-hexamethylene diisocyanate.

15. The endless belt according to claim 1, wherein the rubber polymer further contains an amine-modifled acrylonitrile-butadiene rubber.

16. The endless belt according to claim 1, wherein a mass ratio of the polycarbonate polyol and the rubber polymer in the composition falls within a range of 30:70 to 70:30.

17. The endless belt according to claim 1, wherein the base layer has a thickness of from 30 to 200 μm.

18. The endless belt according to claim 17, wherein the elastic: layer has a thickness of from 30 to 300 μm.

19. The endless belt according to claim 1, wherein the composition further contains at least one selected from the group consisting of an organic flame retardant, an inorganic flame retardant, and a halogen-based flame retardant.

20. The endless belt according to claim 19, wherein the composition further contains at least one of an ion conductive agent and an electroconductive agent.
